(19) United States
(12) Patent Application Publication
(10) Pub. No.: US 2022/0197819 A1
(43) Pub. Date: Jun. 23, 2022

(54) DYNAMIC LOAD BALANCING FOR POOLED MEMORY

(71) Applicant: Intel Corporation, Santa Clara, CA (US)

(72) Inventors: Karthik KUMAR, Chandler, AZ (US); Francesc GUIM BERNAT, Barcelona (ES); Thomas WILLHALM, Sandhausen (DE); Marcos E. CARRANZA, Portland, OR (US); Cesar Ignacio MARTINEZ SPESSOT, Hillsboro, OR (US)

(21) Appl. No.: 17/691,743

(22) Filed: Mar. 10, 2022

(51) Int. Cl. G06F 12/109; G06F 12/14

(52) U.S. Cl. CPC G06F 12/109; G06F 12/1408

(57) ABSTRACT

Examples described herein relate to a memory controller to allocate an address range for a process among multiple memory pools based on a service level parameters associated with the address range and performance capabilities of the multiple memory pools. In some examples, the service level parameters include one or more of latency, network bandwidth, amount of memory allocation, memory bandwidth, data encryption use, type of encryption to apply to stored data, use of data encryption to transport data to a requester, memory technology, and/or durability of a memory device.

### DESCRIPTION

Cloud computing provides a client device with access to computing and storage resources of remote computers. The client can make use of a remote computer or cluster of computers to perform a variety of processing or computing operations as well as remote data processing and data storage or retrieval. For example, a client can be a smart phone, Internet-of-Things (IoT) compatible device such as a smart home, building appliance (e.g., refrigerator, light, camera, or lock), wearable device (e.g., health monitor, smart watch, smart glasses), connected vehicle (e.g., self-driving car), and smart city (e.g., traffic sensor, parking sensor, energy use sensor).

Some remote clusters of devices include one or more memory pools that are accessible by one or more compute nodes. Cloud service providers can add infrastructure and servers to support Infrastructure as a Service (IaaS) and Platform as a Service (PaaS). Some solutions expand memory capacity by adding new pools of memory. Memory pooling technology provides memory devices of use by applications, which can handle variations in memory requirements and lower total cost of ownership (TCO). For example, for in-memory databases, where data is held in memory, when analytical reports are generated at the end of a quarter, a given application may have a spike in memory capacity and bandwidth utilization, due to heavy processing. With memory pooling, instead of having to provision memory usage for the worst case capacity scenario, memory can be provisioned for an average usage, and memory can be borrowed from the memory pool on an as-needed basis.

### BRIEF DESCRIPTION OF THE DRAWINGS

FIG. 1A depicts a scenario that uses memory pooling.

FIG. 1B depicts an example of memory utilization spikes in capacity and bandwidth.

FIG. 2 depicts an example system.

FIG. 3 depicts an example system.

FIG. 4 depicts an example process.

FIG. 5 depicts an example process.

FIG. 6 depicts an example system.

FIG. 7 depicts an example system.

### DETAILED DESCRIPTION

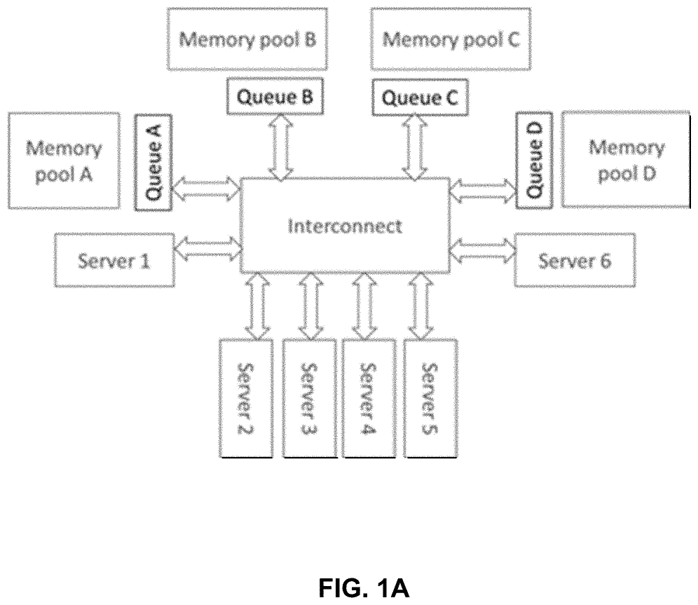

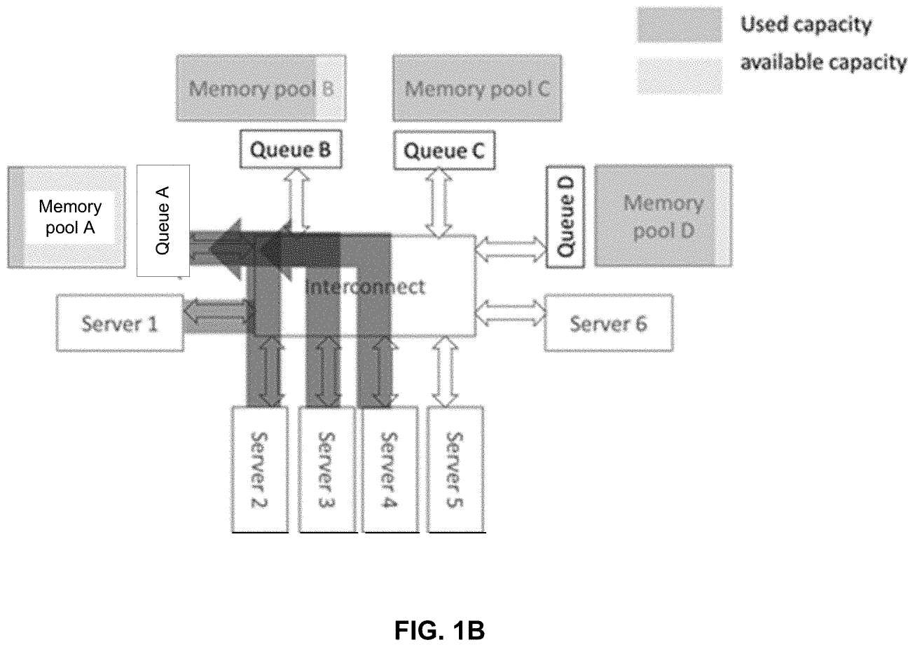

FIG. 1A depicts a scenario that uses memory pooling. Consider for example, a scenario with multiple servers, numbered 1 through 6, that are able to access memory pools labeled A, B, C, and D. In a pooled memory architecture, memory controllers may provide access to a multitude of remote dual inline memory modules (DIMMs) that connected through a particular interconnect. Memory pools can have different data access latency characteristics relative to a server whereby the server can write or read with some memory pools faster than other memory pools. With memory pooling technologies, a server can utilize memory from multiple pools to memory address capacity requirements. However, bandwidth and latency disparities among memory pools may not be addressed.

FIG. 1B depicts an example of memory utilization spikes in capacity and bandwidth, as the spike in capacity to perform memory access operations is accompanied by a spike in network (e.g., interconnect) bandwidth utilization to perform the memory access operations. In this example, a spike in network bandwidth utilization occurs for memory access requests to queue A associated with memory pool A, as multiple servers, namely servers 1-4, provide memory access requests to queue A. If tenants are allocated use of a single pool, memory pool A, then memory access requests to memory pool A can overload the interconnect and increase latency of traversal of memory access requests to memory pool A and from memory pool A to a destination server (e.g., server 1-4). Memory pools can be unequally utilized as memory pool A can be overused relative to memory pools B-D. Latency can represent a time from when a request to read or write data is sent to a time when the data is received at a memory accessible by the requester or a time when the data is written to a target memory.

At least to partially address network bandwidth usage (e.g., fabric, interconnect, or interface bandwidth usage) of a memory pool or pools being overutilized, for a tenant or process, an address range can be allocated among multiple memory pools based on a class of service (CLOS) associated with the address range and performance capabilities of the multiple memory pools. Performance capabilities can be monitored by telemetry data. A memory controller configured with SLAs and accessible memory pools can control allocation of memory pools in cloud native memory to one or more processes. Examples of SLA parameters can include one or more of: latency, network bandwidth, memory allocation, memory bandwidth, network bandwidth, data encryption use or non-use, type of encryption to apply to stored data (e.g., symmetric encryption, asymmetric encryption, Advanced Encryption Standard (AES), Rivest-Shamir-Adleman (RSA), Triple Data Encryption Standard (DES)), use of data encryption to transport data to a requester (e.g., Secure Sockets Layer (SSL), Transport Layer Security (TLS) (e.g., RFC 8446 (2018)), or others), durability of a memory device, or others.

Allocation application program interfaces (APIs) or configuration files can be utilized to request an allocated capacity of memory, allocated bandwidth of network, memory bandwidth, and/or other SLA parameters. To provide an allocation of memory capacity (e.g., amount of memory), network, memory bandwidth, or other SLA parameters, an orchestrator can perform load balancing of usage of multiple memory pools. The orchestrator can receive and manage memory allocation requests from servers and their memory controllers. The orchestrator can receive a request for an allocation of memory capacity, network, and/or memory bandwidth from an application. For example, memory bandwidth can refer to a rate at which data can be read from or stored into a memory device (e.g., bytes/second).

The orchestrator can request allocation of memory that is potentially interleaved among multiple memory pools or multiple memory devices in a single memory pool to support requested network and memory bandwidth or network and memory bandwidth in excess of requested bandwidth. The orchestrator can balance memory access latency and network bandwidth by allocating memory capacity via interleaving across multiple pools. The orchestrator can receive and track current and predicted network and memory bandwidth usages across one or more pools in order to allocate capacity in memory pools based on anticipated future utilization of network bandwidth and memory bandwidth. In some examples, predicted memory access traffic within a memory pool on certain days of the month can be considered in determining whether a memory device and/or memory pool can satisfy a service level for a process. For example, if certain applications are predicted to utilize a certain amount of memory and network bandwidth on certain days of the month, data can be migrated and stored in a manner to balance memory and network bandwidth across multiple memory pool and to potentially avoid memory and network bandwidth of a subset of available memory pools being overloaded to the point of not meeting applicable service level agreement (SLA) parameters.

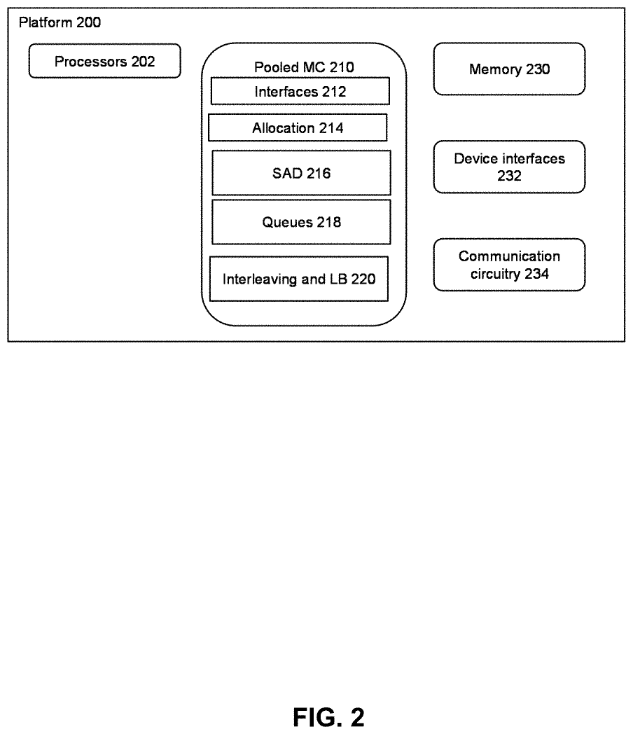

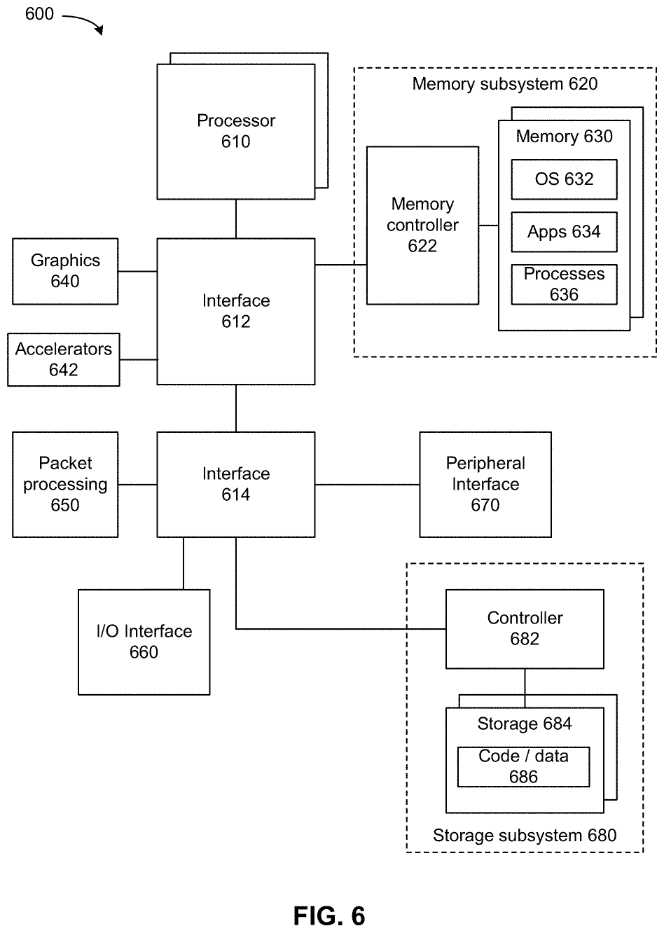

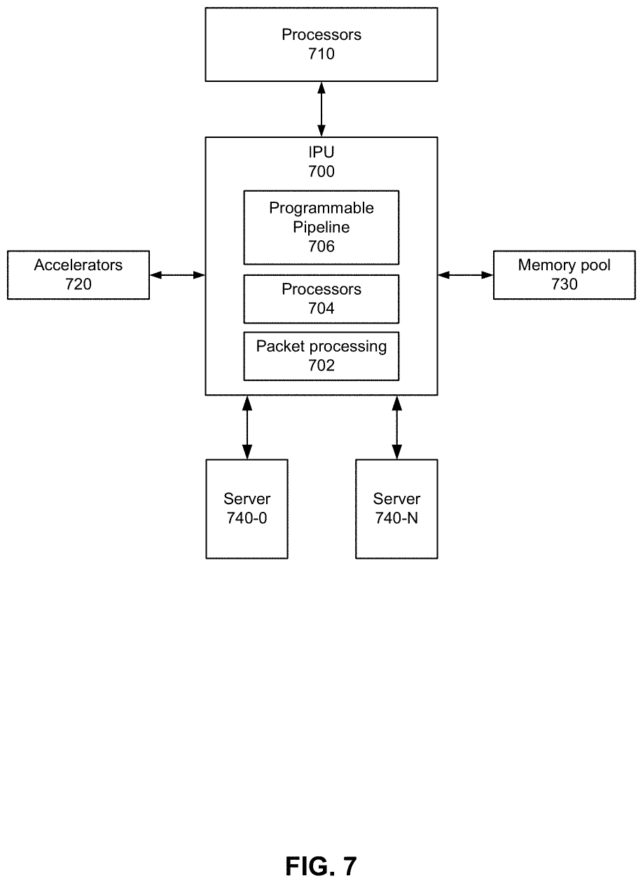

FIG. 2 depicts an example system. Computing platform 200 can include one or more processors 202, one or more memory devices 230, one or more device interfaces 232, and one or more communication circuitry 234. Computing platform 200 can include or utilize pooled memory controller (MC) 210 to provide access to a memory pool accessible through device interfaces 232 and/or communication circuitry 234. For example, platform 200 can be implemented as a server, rack of servers, or others. In some examples, platform 200 can be formed as a system on chip (SoC). Platform 200 can include one or more elements described with respect to systems of FIG. 6 or 7.

Processors 202 can include one or more of: central processing units (CPUs), cores, graphics processing units (GPUs), field programmable gate array (FPGA), application specific integrated circuit (ASIC), accelerators, and/or circuitry. In some examples, processors 202 can be sold or designed by Intel®, ARM®, AMD®, Nvidia®, Broadcom®, Qualcomm®, IBM®, Texas Instruments®, among others. For example, processors 202 can execute a process that includes one or more of: applications, virtual machines, containers, microservices, serverless applications, and so forth.

A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

Memory 230 can include one or more of: one or more registers, one or more cache devices (e.g., level 1 cache (L1), level 2 cache (L2), level 3 cache (L3), lower level cache (LLC)), volatile memory device, non-volatile memory device, or persistent memory device. For example, memory 230 can include static random access memory (SRAM) memory technology or memory technology consistent with high bandwidth memory (HBM), or double data rate (DDR), among others. Memory 230 can be connected to processors 202 and/or communication circuitry 234 using device interfaces 232. Device interfaces 232 can include technologies consistent with a Joint Electronic Device Engineering Council (JEDEC) double data rate (DDR) standard, Compute Express Link (CXL) (e.g., Compute Express Link Specification revision 2.0, version 0.9 (2020), as well as earlier versions, revisions or variations thereof), Peripheral Component Interconnect express (PCIe) (e.g., PCI Express Base Specification 1.0 (2002), as well as earlier versions, revisions or variations thereof), or other interfaces.

Pooled memory controller 210 can allocate an address range among multiple memory pools (described herein) based on a class of service (CloS) associated with the address range and performance capabilities of the multiple memory pools. A process executed by one or more of processors 202 can utilize an application program interface (API) or configuration file to request pooled memory controller 210 to allocate a capacity of memory and bandwidth of network and/or memory bandwidth for the process. In some examples, a process executed by one or more of processors 202 can issue a call (e.g., API) for an allocation of memory one or more memory pools with a particular SLA. Pooled memory controller 210 can be configured by an operating system (OS) executed by one or more of processors 202 and/or an orchestrator to provide memory bandwidth allocation associated with a particular SLA.

Pooled memory controller 210 can utilize interleaving and load balancing (LB) 220 to allocate memory address ranges among one or more memory pools to provide a level of memory bandwidth for a CloS and to achieve a requested SLA (e.g., memory allocation, memory bandwidth, and/or network bandwidth) for one or more processes. For interleaving among multiple memory devices, an address range granularity can be dynamically determined to meet or exceed SLA requirements.

An example of interleaving is described next. For example, consider the pools in Table 1, if an allocation of 200 GB capacity and 200 GB/s memory bandwidth is to be made, pool A is not selected, but pool B or C can be selected. However, memory bandwidth available from pool B or C may not provide sufficient bandwidth headroom. Interleaving between pools B and C provides 100 GB of addresses with 100 GB/s bandwidth from pools B and C. Table 2 depicts a remaining available allocation from pools A to C.

TABLE 1

| Pools | A | | B | | C | |
|---|---|---|---|---|---|---|
| Bandwidth | 100 | GB/s | 300 | GB/s | 200 | GB/s |
| available | | | | | | |
| Capacity | 300 | GB | 200 | GB | 200 | GB |
| available | | | | | | |

TABLE 2

| Pools | A | | B | | C | |
|---|---|---|---|---|---|---|
| Bandwidth | 100 | GB/s | 200 | GB/s | 100 | GB/s |
| available | | | | | | |
| Capacity | 300 | GB | 100 | GB | 100 | GB |
| available | | | | | | |

For a request to allocate memory bandwidth of 400 GB/s and capacity of 300 GB, 100 GB of capacity from pools A-C and memory bandwidths in the pools A-C can be allocated for the request. Capacity allocation ratios can be unequally allocated (e.g., 1:2:1) among the pools to meet bandwidth requests across the pools.

Pooled memory controller 210 can select from one or more classes of bandwidth (e.g., best effort, BW1, . . . , BWn) for allocation to a CloS and/or a process. For example, a class of memory bandwidth BW1 can be higher than a memory bandwidth BW2 and so forth. Best effort memory bandwidth can provide available memory bandwidth but no lower limit on memory bandwidth. Pooled memory controller 210 can dynamically create classes of bandwidth for allocation to a CloS based on memory bandwidth of an associated SLA.

Pooled memory controller 210 can utilize queues 218, which can include an integer N queues, allocated to store host requests targeting address spaces associated with a particular service level objective. Pooled memory controller 210 can utilize queues 218 to buffer data before the data is sent to a memory pool. Interleaving and LB 220 can select memory access requests (e.g., read, write, administrative) stored in various queues to attempt to satisfy an SLA associated with a process. There may be multiple instances of load balancers (e.g., one per queue). Pooled MC 210 can be separate from a local MC to local memory 230 or integrated with local MC to local memory 230. Interleaving and LB 220 can perform scheduling of issuance of memory access requests to one or more target memory pools based on network and/or memory bandwidth parameters associated with a process that issued a memory access request. In some examples, individual memory access requests can be associated SLAs and interleaving and LB 220 can perform scheduling of issuance of memory access based on SLAs associated with individual memory access requests.

Based on memory bandwidth available at memory pools and network bandwidth to the memory pools, allocation 214 can select one or more memory pools to associate with an address range for a process. For example, a network device in a network can provide network bandwidth telemetry indicative of current and historic network bandwidth utilization to and from different memory pools. For example, a memory pool can provide a memory map (mmap) with an indicator of an expectation of a memory bandwidth for a particular CloS. In some examples, allocation 214 can select one or more memory pools to associate with an address range for a process based on predicted network traffic to and from the selected memory pool(s) for when spikes or increases in memory access requests are expected to occur. Pooled memory controller 210 can utilize allocation 214 to allocate address ranges to address ranges in selected memory pools. As described herein, queues and fabric resources in a memory pool can be utilized and allocated to support meeting or exceeding SLA requirements.

System Address Decoder (SAD) 216 can be configured with an address maps to indicate a target memory pool to associate with a target memory address in a memory access request. SAD 216 can be updated based on data migration within a memory pool or to another memory pool. For example, SAD 216 can map a process identifier (e.g., Process Address Space identifier (ID) (PASID) to one or more of: memory address range, Class of Service (CloS), or pooled memory list.

Pooled memory controller 210 can be implemented as one or more of: programmable general-purpose or special-purpose microprocessors, field programmable gate arrays (FPGAs), digital signal processors (DSPs), programmable controllers, application specific integrated circuits (ASICs), programmable logic devices (PLDs), or the like, or a combination of such devices.

Communication circuitry 234 can include one or more of: a network interface controller (NIC), host fabric interface (HFI), and other examples described herein. Platform 200 can communicate with one or more memory pools using device interfaces 232 and/or communication circuitry 234 based on various protocols. For example, a locally attached memory pool via device interface 232 can be accessible as an NVMe device (e.g., NVMe specification, version 1.0e (2013)). For example, a memory pool can be accessible using NVMe-oF (e.g., NVMe-oF™ Specification version 1.0 (2016)), remote direct memory access (RDMA), and related protocols.

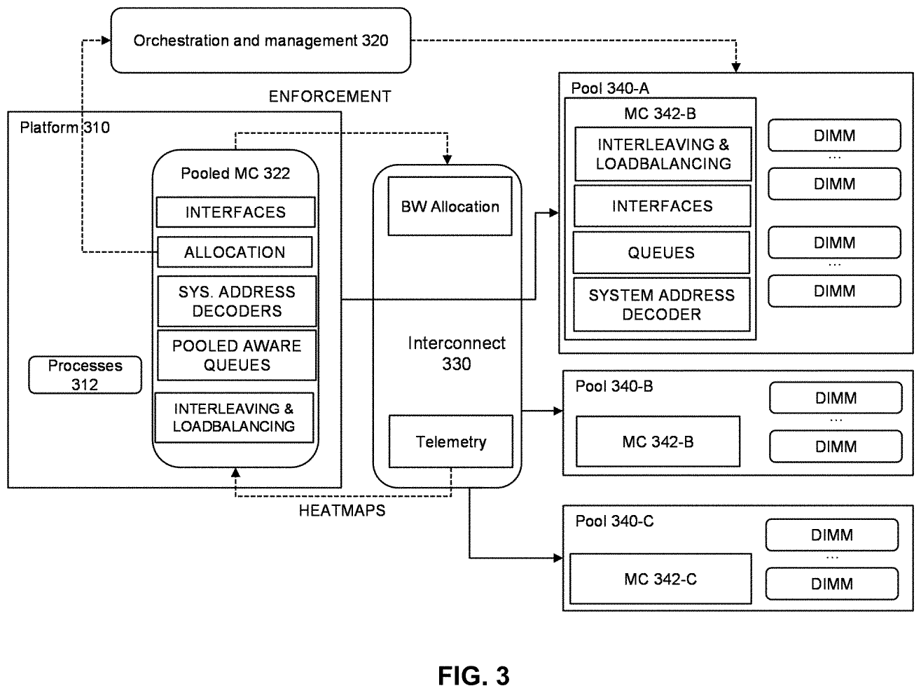

FIG. 3 depicts an example system. Computing platform 310 can execute one or more processes 312 that utilize pooled memory controller 322 to access one or more memory pools 340-A to 340-C. Memory regions in one or more memory pools 340-A to 340-C can be allocated for access by one or more processes 312.

Processes 312, executed by one or more processors in platform 310, can query orchestrator 320 or pooled MC 322 to determine available CloS of memory and network bandwidth. Processes 312 can request CloS to be allocated by pooled MC 322 for a particular process identifier (e.g., PASID). At boot time, N CloS can be defined and mapped into corresponding queues (e.g., queues 218) and a subset of CloS may dynamically change (e.g., associated queues can be flushed and pooled memory data erased or merged). In some examples, orchestrator 320 and/or processes 312 can utilize an interface to allocate CloS IDs with associated memory bandwidth, latency, and other metrics. The interface can request association of a CloS ID with memory bandwidth, network bandwidth between platform 310 and one or more memory pools, and/or a particular latency between platform 310 and one or more memory pools.

Processes 312 can utilize an interface (e.g., API and/or configuration file) to request pooled memory controller 322 to allocate memory address space in one or more memory pools for a particular process identifier and CloS. An interface can be utilized to request CloS and amount of memory for a particular PASID. The interface can trigger pooled memory controller 322 to request orchestrator 320 to select one or more memory pools to associate with a corresponding address space to meet the request. The selection of one or more memory pools to associate with a corresponding address space can be based on network traffic data and predicted network traffic to and from the selected memory pool(s) from interconnect 330. Interconnect 330 can provide the network traffic data between the platform to and from the selected memory pool(s) and predicted network traffic between the platform to and from the selected memory pool(s). In some examples, interconnect 330 can indicate to orchestrator 320 and/or platform 322 a heatmap of traffic to or from memory pools 340-A to 340-C. Network traffic monitoring and memory bandwidth monitoring technologies in interconnect 330 can provide a heatmap of traffic to or from memory pools 340-A to 340-C. Interconnect 330 can be implemented as one or more of: fabric, network, interconnect, bus, or other interface.

In some examples, predicted memory access traffic within a memory pool on certain days of the month can be considered in determining whether a memory device and/or memory pool can satisfy a service level for a process. In some examples, durability of a memory device and/or error proneness of a memory device can be considered in determining whether a memory device and/or memory pool can satisfy a service level for a process.

One or more of memory pools 340-A to 340-C can include one or more dual in-line memory modules (DIMMs), or other volatile or non-volatile memory devices. At least two levels of memory (alternatively referred to herein as “2LM” or tiered memory) can be used that includes cached subsets of system disk level storage (in addition to, for example, run-time data). This main memory includes a first level (alternatively referred to herein as “near memory”) including smaller faster memory made of, for example, dynamic random access memory (DRAM) or other volatile memory; and a second level (alternatively referred to herein as “far memory”) which includes larger and slower (with respect to the near memory) volatile memory (e.g., DRAM) or nonvolatile memory storage (e.g., flash memory or byte addressable non-volatile memory (e.g., Intel Optane®)). The far memory is presented as “main memory” to the host operating system (OS), while the near memory is a cache for the far memory that is transparent to the OS, thus rendering the embodiments described below to appear the same as prior art main memory solutions. The management of the two-level memory may be performed by a combination of circuitry and modules executed via the host central processing unit (CPU). Near memory may be coupled to the host system CPU via high bandwidth, low latency means for efficient processing. Far memory may be coupled to the CPU via low bandwidth, high latency means (as compared to that of the near memory). In some examples, one or more of memory pools 340-A to 340-C can include in far memory.

Based on selection of pooled memories, workload and resource orchestrator 320 can allocate memory address ranges in the selected pooled memories. Orchestrator 320 can communicate to pooled MC 322 one or more of: available memory space in memory pools and historic memory bandwidth usage of pools. Orchestrator 320 can use an interface (e.g., API or configuration file) to pooled memory controller 322 to create a memory address space for a particular application with a particular class of service. Orchestrator 320 can cause migration of data within a memory pool or to another memory pool to provide an allocation of available memory addresses among one or more memory pools for a particular CloS and associated SLA (e.g., memory bandwidth and/or network bandwidth between platform 310 and one or more memory pools 340-A to 340-C). For example, based on a request for a particular range of memory addresses for a particular CloS and SLA, orchestrator 320 can cause migration of data (and potentially update memory pool mappings in a SAD to locate a location of the migrated data) to make available a requested memory range associated with a particular CloS and SLA. Orchestrator 320 can be implemented as software executed by one or more processors on a computing platform that is coupled to platform 310. Various examples of orchestrator 320 can include Kubernetes, Amazon Web Services (AWS) CloudFormation, Azure Automation, Docker Swarm, Mesos, and so forth.

In some examples, orchestrator 320 can be implemented as a hypervisor or container manager and processes (e.g., VMs, containers, microservices, or others) can request an allocation of memory by an API. Orchestrator 320 can be configured specific SLA parameters for the process and configure the memory in one or more memory pools based on SLA parameters

For example, the following Table 3 provides an example of association between PASIDs, CloS, address range, and pooled memories.

TABLE 3

| | | | POOLED |
|---|---|---|---|
| PASID | CLOS | @RANGE | MEMORIES |
| ID | CLOS | [A, B] | LIST |
| 0X33 | 1 | [0X2342- | POOL A |
| | | 0X4343] | |
| . . . | . . . | . . . | . . . |

A SAD of pooled MC 322 can utilize contents of Table 1 to provide an address conversion and target memory pool for a memory access request.

Interconnect 330 can provide communication among platform 322 and one or more memory pools 340-A to 340-C using one or more of: a network, fabric, device interface, or interconnect. Interconnect 330 can allocate bandwidth to interleaving and load balancing of pooled MC 322 to schedule memory access requests from queues based on applicable SLA. For example, Table 4 provides an example configuration of a CloS identifier to memory bandwidth and latency (LAT). Static SLA can represent an unconditioned allocation of resources. Dynamic SLA can represent a conditioned allocation of resources. An example dynamic SLA can be: if temperature>X, allocation A GB/s bandwidth else B GB/s bandwidth or if network bandwidth<B1 and load<50%, then latency SLA is 2 ms, else if load>50 ms, latency SLA is 3 ms.

TABLE 4

| | | STATIC/ |
|---|---|---|
| CLOS ID | SLA | DYNAMIC |
| ID | Bandwidth (BW) or latency | YES/NO |
| 0X33 | 500 MB/S | YES |
| . . . | . . . | |

Memory pools 340-A to 340-C can include communication circuitry (not shown), processors (e.g., CPUs, GPUs, accelerators, and so forth), and memory pool resources (e.g., DIMMs with one or more of: volatile memory, non-volatile memory, persistent memory, storage, and/or cache). Memory pools 340-A to 340-C can include different memory technologies with different read or write rates.

Memory controllers 342-A to 342-C in respective memory pools 340-A to 340-C can allocate memory bandwidth among memory technologies to provide memory bandwidth in compliance with SLAs associated with process-issued memory access requests. One or more of memory controllers 342-A to 342-C can utilize address interleaving among different memory devices (e.g., DMMs), queues, scheduling and load balancing to satisfy an applicable SLA (e.g., memory bandwidth and/or latency). For example, N types of queues can be associated with different or overlapping SLAs. For example, memory access requests targeting address spaces associated with a particular SLA can be stored into a particular queue. A load balancer can arbitrate selection of requests from one or more queues to satisfy the associated SLA. There may be multiple instances of load balancers, such as a load balancer per queue. For instance, if an SLA of memory bandwidth is 4 GB/s and interleaving selects 4 pooled memories, the pooled memory can read or write data at approximately 1 GB/s.

One or more of memory controllers 342-A to 342-C can include or utilize a system address decoder (SAD) that can map an address range in a memory access request to an address range in a memory pool. The SAD can record the interleaving of addresses with memory devices (e.g., DIMM) and can decode requests to direct requests to target memory devices. For example, a SAD can associate PASID of the application with one or more of: Class of Service and memory range. For example, the following Table 5 provides an example of associating between a PASID, CloS, and address range.

TABLE 5

| PASID | CLOS | Address Range |
|---|---|---|
| ID | CLOS | [A, B] |
| 0X33 | 1 | [0X2342-0X4343] |
| . . . | . . . | . . . |

One or more of memory controllers 342-A to 342-C can be implemented as one or more of: programmable general-purpose or special-purpose microprocessors, field programmable gate arrays (FPGAs), digital signal processors (DSPs), programmable controllers, application specific integrated circuits (ASICs), programmable logic devices (PLDs), or the like, or a combination of such devices.

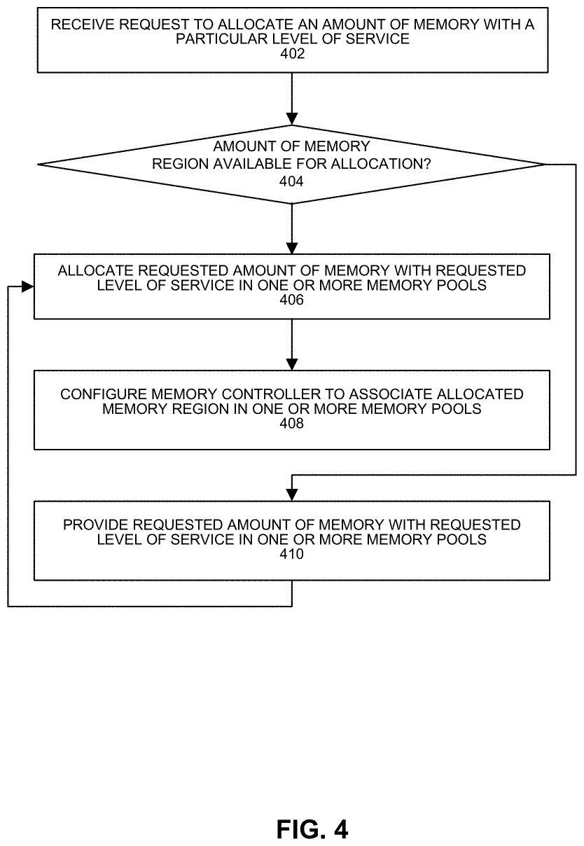

FIG. 4 depicts an example process. The process can be performed by an orchestrator or management software that is capable of allocating memory addresses associated with memory devices in memory pools for use by one or more processes. At 402, a request to allocate an amount of memory for a particular CloS and SLA can be received. The request can be received from a process and/or memory controller, such as a pooled memory controller. At 404, based on availability of the amount of memory in one or more memory pools to meet the request, the process can proceed to 406. At 404, based on unavailability of the amount of memory in one or more memory pools to meet the request, the process can proceed to 410.

At 406, the orchestrator can allocate the amount of requested memory in one or more memory pools. Selection of memory pools can be based on meeting particular requested SLA and can be based at least on network traffic between a platform that executes the process that requested the allocation and the selected one or more memory pools, memory bandwidth of the selected one or more memory pools, expected latency of transit of data between the platform that executes the process that requested the allocation and the selected one or more memory pools. At 408, the memory controller can be configured to identify memory addresses allocated in the selected one or more memory pools to the requester process. The memory controller can be utilized by the requester process. For example, if allocated memory addresses are interleaved among multiple memory pools and/or multiple memory devices in a memory pool, the memory controller can be configured with allocated memory addresses so that memory access requests can be issued to the correct target memory pools that are associated with allocated memory addresses.

At 410, operations can be performed to provide an available allocation of the requested amount of memory. For example, data can be migrated to other memory devices and/or memory pools to provide an available allocation of the requested amount of memory. For example, additional memory pools can be made available to provide an available allocation of the requested amount of memory. The process can continue to 406.

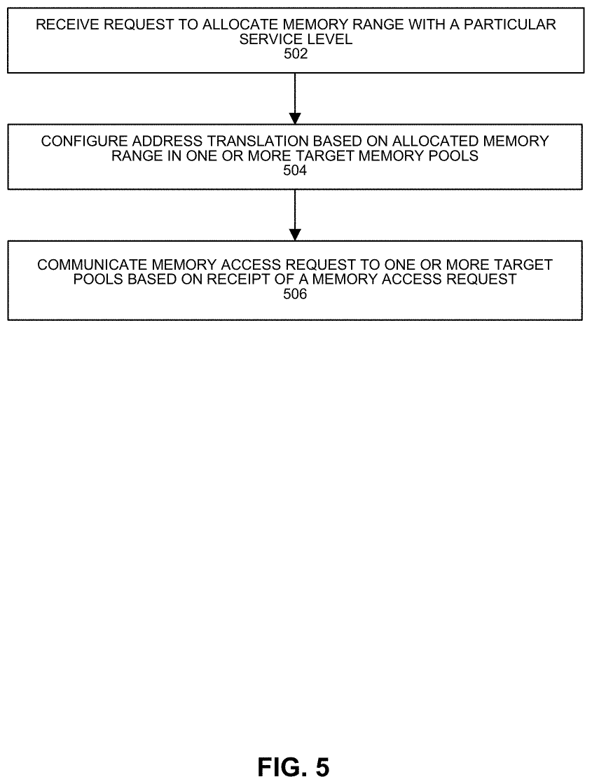

FIG. 5 depicts an example process. The process can be performed by a memory controller utilized by a process executing on a platform. At 502, a request can be received to allocate an amount of memory for a particular CloS and SLA. The request can be received from a process. At 504, a configuration can be received to allocate memory addresses in one or more memory pools that are allocated to satisfy request to access memory from process. The configuration can identify allocated memory addresses in target memory pools that are associated with memory addresses in memory access requests from the process. At 506, based on receipt of a memory access request, the received memory access request can be transmitted or communicated to one or more target memory pools. Various communication schemes can be used to communicate the one or more memory access requests such as NVMe, NVMe-oF, RDMA, and others. The target memory pools can provide data in response to a memory access read request and/or write data in response to a memory access write request.

FIG. 6 depicts a system. The system can use examples described herein to access memory pools, as described herein. In some examples, a memory pool can include components of the system 600. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some examples, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

In some examples, memory controller 622 can be configured to allocate memory addresses in one or more memory pools based on a CloS and service level for one or more applications 634, as described herein.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Broadcom®, Nvidia®, Texas Instruments®, among others. In some examples, a driver can advertise capability of packet processing device 650 and/or enable packet processing device 650 to transmit a packet with network resource consumption data to a sender, request network resource consumption data, and/or modify transmission of packets based on received network resource consumption data, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Packet processing device 650 provides system 600 the ability to communicate with remote devices (e.g., servers or other computing devices) over one or more networks. Packet processing device 650 can include an Ethernet adapter, wireless interconnection components, cellular network interconnection components, USB (universal serial bus), or other wired or wireless standards-based or proprietary interfaces. Packet processing device 650 can transmit data to a device that is in the same data center or rack or a remote device, which can include sending data stored in memory. Packet processing device 650 can receive data from a remote device, which can include storing received data into memory.

Some examples of packet processing device 650 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a packet processing device with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Processor 610 and packet processing device 650 can offload, to a switch, determination of nodes to execute microservices of a service mesh and select a memory pool or device to store data and state associated with or generated by microservices of the service mesh. In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

Packet processing device 650 can include a programmable processing pipeline that is programmable by P4, C, Python, Broadcom Network Programming Language (NPL), NVIDIA® CUDA®, NVIDIA® DOCA™, or x86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM). A memory subsystem as described herein may be compatible with a number of memory technologies, such as standards released by JEDEC (Joint Electronic Device Engineering Council) on Jun. 27, 2007).

A non-volatile memory (NVM) device is a memory whose state is determinate even if power is interrupted to the device. In some examples, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, packet processing devices, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, packet processing device and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

FIG. 7 depicts an example system. In this system, IPU 700 manages performance of one or more processes using one or more of processors 710, accelerators 720, memory pool 730, or servers 740-0 to 740-N, where N is an integer of 1 or more. In some examples, processors 704 of IPU 700 can execute one or more processes, applications, VMs, containers, microservices, and so forth that request performance of workloads by one or more of: processors 710, accelerators 720, memory pool 730, and/or servers 740-0 to 740-N. IPU 700 can utilize packet processing device 702 or one or more device interfaces to communicate with processors 710, accelerators 720, memory pool 730, and/or servers 740-0 to 740-N. IPU 700 can utilize programmable pipeline 706 to process packets that are to be transmitted from packet processing device 702 or packets received from packet processing device 702. In some examples, IPU 700 can utilize a memory controller to access a memory address range for a particular process executed by IPU 700 in one or more memory pools.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in examples.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative examples. Furthermore, additional operations may be added or removed depending on the particular applications. Any combination of changes can be used and one of ordinary skill in the art with the benefit of this disclosure would understand the many variations, modifications, and alternative examples thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An example of the devices, systems, and methods may include any one or more, and any combination of, the examples described below.

Example 1 includes one or more examples, and includes an apparatus comprising: a memory controller to allocate an address range for a process among multiple memory pools based on a service level parameters associated with the address range and performance capabilities of the multiple memory pools.

Example 2 includes one or more examples, wherein the service level parameters comprise one or more of latency, network bandwidth, amount of memory allocation, memory bandwidth, data encryption use, type of encryption to apply to stored data, use of data encryption to transport data to a requester, memory technology, and/or durability of a memory device.

Example 3 includes one or more examples, wherein the performance capabilities of the multiple memory pools are based on one or more of: latency, network bandwidth, amount of memory allocation, memory bandwidth, data encryption use, type of encryption to apply to stored data, use of data encryption to transport data to a requester, memory technology, and/or durability of a memory device.

Example 4 includes one or more examples, wherein the allocate an address range for a process among multiple memory pools comprises allocate address translations to the address range based on the multiple memory pools that store data associated with the address range.

Example 5 includes one or more examples, wherein to allocate an address range for a process among multiple memory pools, the memory controller is to dynamically distribute mapped addresses within the allocated address range among one or more of the multiple memory pools by an interleave of the allocated address range among the multiple memory pools.

Example 6 includes one or more examples, and includes one or more queues associated with one or more classes of service, wherein the one or more queues are to provide a class of service differentiation for issuance of memory access requests to the multiple memory pools.

Example 7 includes one or more examples, wherein the multiple memory pools are selected based on the performance capabilities of the multiple memory pools meeting the service level parameters associated with the address range.

Example 8 includes one or more examples, and includes a network interface device and the multiple memory pools, wherein the network interface device is to issue one or more memory access requests to the multiple memory pools.

Example 9 includes one or more examples, and includes one or more processors to execute the process, wherein the one or more processors are communicatively coupled to the memory controller.

Example 10 includes one or more examples, and includes a datacenter, wherein the datacenter includes the multiple memory pools and a server that is to execute an orchestrator to select the multiple memory pools based on the performance capabilities of the multiple memory pools meeting the service level parameters associated with the address range.

Example 11 includes one or more examples, and includes at least one non-transitory computer-readable medium, comprising instructions stored thereon, that if executed by at least one processor, cause the at least one processor to: configure a memory controller to allocate an address range for a process among multiple memory pools based on a service level parameters associated with the address range and performance capabilities of the multiple memory pools.

Example 12 includes one or more examples, wherein the service level parameters comprise one or more of latency, network bandwidth, amount of memory allocation, memory bandwidth, data encryption use, type of encryption to apply to stored data, use of data encryption to transport data to a requester, memory technology, and/or durability of a memory device.

Example 13 includes one or more examples, wherein the performance capabilities of the multiple memory pools are based on one or more of: latency, network bandwidth, amount of memory allocation, memory bandwidth, data encryption use, type of encryption to apply to stored data, use of data encryption to transport data to a requester, memory technology, and/or durability of a memory device.

Example 14 includes one or more examples, wherein the allocate an address range for a process among multiple memory pools comprises allocate address translations to the address range based on the multiple memory pools that store data associated with the address range.

Example 15 includes one or more examples, wherein the allocated address range is interleaved among the multiple memory pools.

Example 16 includes one or more examples, wherein to allocate an address range for a process among multiple memory pools, the memory controller is to dynamically distribute mapped addresses within the allocated address range among one or more of the multiple memory pools by an interleave of the allocated address range among the multiple memory pools.

Example 17 includes one or more examples, and include a method comprising: a memory controller allocating an address range for a process among multiple memory pools based on a service level parameters associated with the address range and performance capabilities of the multiple memory pools.

Example 18 includes one or more examples, wherein the service level parameters comprise one or more of latency, network bandwidth, amount of memory allocation, memory bandwidth, data encryption use, type of encryption to apply to stored data, use of data encryption to transport data to a requester, memory technology, and/or durability of a memory device.

Example 19 includes one or more examples, wherein the performance capabilities of the multiple memory pools are based on one or more of: latency, network bandwidth, amount of memory allocation, memory bandwidth, data encryption use, type of encryption to apply to stored data, use of data encryption to transport data to a requester, memory technology, and/or durability of a memory device.

Example 20 includes one or more examples, wherein the allocating an address range for a process among multiple memory pools comprises dynamically distributing mapped addresses within the allocated address range among one or more of the multiple memory pools by interleaving the allocated address range among the multiple memory pools.

Example 21 includes one or more examples, and includes at least one non-transitory computer-readable medium, comprising instructions stored thereon, that if executed by at least one processor, cause the at least one processor to: execute an orchestrator to allocate an amount of memory among multiple memory pools that meet service level parameters associated with a process.

Example 22 includes one or more examples, wherein the orchestrator comprises a hypervisor or container manager.

What is claimed is:

1. An apparatus comprising:
a memory controller to allocate an address range for a process among multiple memory pools based on a service level parameters associated with the address range and performance capabilities of the multiple memory pools.

2. The apparatus of claim 1, wherein the service level parameters comprise one or more of latency, network bandwidth, amount of memory allocation, memory bandwidth, data encryption use, type of encryption to apply to stored data, use of data encryption to transport data to a requester, memory technology, and/or durability of a memory device.

3. The apparatus of claim 1, wherein the performance capabilities of the multiple memory pools are based on one or more of: latency, network bandwidth, amount of memory allocation, memory bandwidth, data encryption use, type of encryption to apply to stored data, use of data encryption to transport data to a requester, memory technology, and/or durability of a memory device.

4. The apparatus of claim 1, wherein the allocate an address range for a process among multiple memory pools comprises allocate address translations to the address range based on the multiple memory pools that store data associated with the address range.

5. The apparatus of claim 1, wherein to allocate an address range for a process among multiple memory pools, the memory controller is to dynamically distribute mapped addresses within the allocated address range among one or more of the multiple memory pools by an interleave of the allocated address range among the multiple memory pools.

6. The apparatus of claim 1, comprising one or more queues associated with one or more classes of service, wherein the one or more queues are to provide a class of service differentiation for issuance of memory access requests to the multiple memory pools.

7. The apparatus of claim 1, wherein the multiple memory pools are selected based on the performance capabilities of the multiple memory pools meeting the service level parameters associated with the address range.

8. The apparatus of claim 1, comprising:
a network interface device and
the multiple memory pools, wherein the network interface device is to issue one or more memory access requests to the multiple memory pools.

9. The apparatus of claim 8, comprising one or more processors to execute the process, wherein the one or more processors are communicatively coupled to the memory controller.

10. The apparatus of claim 9, comprising a datacenter, wherein the datacenter includes the multiple memory pools and a server that is to execute an orchestrator to select the multiple memory pools based on the performance capabilities of the multiple memory pools meeting the service level parameters associated with the address range.

11. At least one non-transitory computer-readable medium, comprising instructions stored thereon, that if executed by at least one processor, cause the at least one processor to:
configure a memory controller to allocate an address range for a process among multiple memory pools based on a service level parameters associated with the address range and performance capabilities of the multiple memory pools.

12. The at least one computer-readable medium of claim 11, wherein the service level parameters comprise one or more of latency, network bandwidth, amount of memory allocation, memory bandwidth, data encryption use, type of encryption to apply to stored data, use of data encryption to transport data to a requester, memory technology, and/or durability of a memory device.

13. The at least one computer-readable medium of claim 11, wherein the performance capabilities of the multiple memory pools are based on one or more of: latency, network bandwidth, amount of memory allocation, memory bandwidth, data encryption use, type of encryption to apply to stored data, use of data encryption to transport data to a requester, memory technology, and/or durability of a memory device.

14. The at least one computer-readable medium of claim 11, wherein the allocate an address range for a process among multiple memory pools comprises allocate address translations to the address range based on the multiple memory pools that store data associated with the address range.

15. The at least one computer-readable medium of claim 11, wherein the allocated address range is interleaved among the multiple memory pools.

16. The at least one computer-readable medium of claim 11, wherein to allocate an address range for a process among multiple memory pools, the memory controller is to dynamically distribute mapped addresses within the allocated address range among one or more of the multiple memory pools by an interleave of the allocated address range among the multiple memory pools.

17. A method comprising:
a memory controller allocating an address range for a process among multiple memory pools based on a service level parameters associated with the address range and performance capabilities of the multiple memory pools.

18. The method of claim 17, wherein the service level parameters comprise one or more of latency, network bandwidth, amount of memory allocation, memory bandwidth, data encryption use, type of encryption to apply to stored data, use of data encryption to transport data to a requester, memory technology, and/or durability of a memory device.

19. The method of claim 17, wherein the performance capabilities of the multiple memory pools are based on one or more of: latency, network bandwidth, amount of memory allocation, memory bandwidth, data encryption use, type of encryption to apply to stored data, use of data encryption to transport data to a requester, memory technology, and/or durability of a memory device.

20. The method of claim 17, wherein the allocating an address range for a process among multiple memory pools comprises dynamically distributing mapped addresses within the allocated address range among one or more of the multiple memory pools by interleaving the allocated address range among the multiple memory pools.

21. At least one non-transitory computer-readable medium, comprising instructions stored thereon, that if executed by at least one processor, cause the at least one processor to:
execute an orchestrator to allocate an amount of memory among multiple memory pools that meet service level parameters associated with a process.

22. The at least one computer-readable medium of claim 21, wherein the orchestrator comprises a hypervisor or container manager.
